(19) United States
(12) Patent Application Publication
(10) Pub. No.: US 2008/0010087 A1
(43) Pub. Date: Jan. 10, 2008

(54) REFERRAL COORDINATION SYSTEMS AND METHODS

(76) Inventors: RONNIE C. DANIEL, TIFTON, GA (US); MARCUS B. LOTT SR., TIFTON, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/668,867

(22) Filed: Jan. 30, 2007

Related U.S. Application Data
(60) Provisional application No. 60/763,650, filed on Jan. 30, 2006.
(60) Provisional application No. 60/875,138, filed on Dec. 15, 2006.

(51) Int. Cl. G06Q 50/00

(52) U.S. Cl. 705/2

(57) ABSTRACT

The present invention provides improved systems and methods for coordinating and processing referrals for products and/or services such as medical treatments. Embodiments of the present invention provide novel systems that allow referring entities to efficiently process and approve referrals electronically. Some embodiments allow a provider to select the reimbursement document format after the referral data has been entered and authorized to facilitate prompt reimbursement.

### CROSS-REFERENCE TO RELATED APPLICATIONS

This patent application is a U.S. Non-provisional application filed pursuant to Title 35, U.S.C. §§100 et seq. and 37 C.F.R. §1.53(b), and claiming priority under Title 35, U.S.C. §119(e) to a U.S. Provisional Application No. 60/763,650, filed Jan. 30, 2006, and U.S. Provisional Application No. 60/875,138, filed Dec. 15, 2006, which are hereby incorporated herein in their entirety by reference.

### BACKGROUND OF THE INVENTION

To secure payment and properly document medical information for a prescribed treatment, providers such as home healthcare companies, physical therapists, and medical clinics navigate a bureaucratic maze created by government agencies and private insurance companies that often results in delayed reimbursements and/or denials of coverage. One critical step in successfully navigating this maze is to select the proper order/authorization form for the associated prescribed treatment and reimbursing entity (e.g., Medicare, Medicaid, Tricare and private insurance companies). Additionally, some reimbursing entities require that the results of specific medical tests fall within a given threshold to prove medical necessity. If the incorrect form is submitted for the given service or the thresholds are not met, reimbursement is often denied. The term “threshold,” as used herein should be interpreted broadly to include numerical thresholds, ranges, or any other criteria or requirements.

“Treatment,” as used herein, may include any type of recommended or prescribed medical service, therapy, products or equipment supplied by any qualified provider. The types of equipment that may be prescribed include but are not limited to the sale or rental of wheelchairs, home oxygen devices, sleep monitors, and nebulizers. The types of services provided include but are not limited to home nursing care, diagnostic testing, home oxygen, and consultation from a specialist such as cardiologist, dermatologist, or chiropractor. Products may include, but are not limited to nebulizer medications and intravenously administered products, both compounded and pre-assembled.

Typically, a physician will refer a patient to a provider for a particular treatment. An individual within the physician's practice, often identified as a referral coordinator, contacts a provider that can satisfy the recommended or prescribed treatment. Details regarding the treatment are communicated to the provider by facsimile or by phone such that the provider is able to provide ordered treatments in an expedient manner.

After the treatment has been provided partially or fully, the provider often needs to secure payment from a reimbursing entity such as Medicare, Medicaid, Tricare or a private insurance company. This typically requires submitting the appropriate order form such as a Statement of Medical Necessity (SMN) or a Certificate of Medical Necessity (CMN) to the respective reimbursing entity.

An SMN document may be used for certain treatments and accepts standard medical diagnostic codes. A majority of the fields on an SMN may be populated by the provider such as the patient's name, address and other identification data along with the standard medical codes for the patient's condition and the associated treatment. Under present regulations, a physician must review and sign the form in order to constitute a legally valid treatment order. Therefore, after populating the SMN using the preliminary data received, the provider forwards it to the physician for her signature. For some treatments, regulations require that specific fields can only be populated by the treating physician. In this case, the physician would complete these fields in addition to signing it. For example, a physician may be required to provide a statement of medical need in addition to signing the form. The form is then returned to the provider for submission to the reimbursing entity. Because the physician may review the form weeks or months after originating the prescription, often the physician will need to refresh her memory before signing the form. This can take precious time away from treating patients and therefore it is not a high priority task. Accordingly, it may take weeks to obtain the physician's signature. Additionally, the physician has to consider the risk of fraudulent orders when the order originates from a source other than that physician.

A CMN is typically required for specific treatments. Accordingly, in some instances government regulations restrict which fields on the form a provider can populate. Therefore, the form is partially populated by the provider based on preliminary information received and it is forwarded to the physician for completion. This typically requires the physician to retrieve the patient's records, populate the fields, and then sign the form. The signed form is then returned to the provider who then submits it for payment. Once again, this is a time consuming task for a very busy physician. Accordingly, the review and signature by the physician can create a significant delay. And again, the possibility of fraudulent orders needs to be given strong consideration.

Therefore, a need exists for systems and methods that streamline the referral and authorization process and address deficiencies in the state of the art, some of which are discussed above. A need also exists for systems and methods that reduce the risk of fraudulent orders.

### BRIEF SUMMARY OF THE INVENTION

The present invention provides improved systems and methods for coordinating and processing referrals for products and/or services that address deficiencies in the art, some of which are discussed above. Embodiments of the present invention provide novel systems that allow referring entities to efficiently process and approve referrals electronically. Some embodiments allow a provider to select the reimbursement document format after the referral data has been entered and authorized to facilitate prompt reimbursement.

In one embodiment, a system for processing a referral for a treatment is provided. This system includes one or more databases configured to store data associated with a plurality of patients; a plurality of treatments including medical data requirements for authorization; a plurality of referring entities; and a plurality of providers including provider profiles; a plurality of access terminals having an input device and a graphical user interface; and a referral coordination server. The referral coordination server is configured to communicate with the one or more databases and the plurality of access terminals and further configured for: receiving information from a user identifying a referring entity from the plurality of referring entities, a patient from the plurality of patients, a treatment from the plurality of treatments and a provider from the plurality of providers; in response to receiving the information, prompting the user to provide medical data required to authorize the treatment; and populating an electronic referral with the medical data and data retrieved from the one or more databases associated with the patient, the referring entity, the treatment and the provider such that the electronic referral includes information sufficient for authorization by an authorizing entity.

In another embodiment, a method for processing a referral for treatment of a patient is provided. This method includes the steps of: providing one or more databases for storing data associated with a plurality of patients, a plurality of referring entities, a plurality of treatments including medical data requirements for authorization, and a plurality of providers; receiving information from a user identifying a referring entity from the plurality of referring entities, a patient from the plurality of patients, a treatment from the plurality of treatments and a provider from the plurality of providers; in response to receiving information, prompting the user to provide medical data required to authorize treatment; and populating an electronic referral with the medical data and data retrieved from the one or more databases associated with the patient, the referring entity, the treatment and the provider such that the electronic referral contains information sufficient for authorization by an authorizing entity.

In a further embodiment, a method for processing a referral is provided. This method includes the steps of: providing one or more databases storing data associated with a plurality of referring entities, a plurality of products or services, and a plurality of providers; receiving information from a user identifying a person being referred, a referring entity from the plurality of referring entities, a product or service from the plurality of products and services and a provider from the plurality of providers; in response to receiving information, prompting the user to provide data required to authorize reimbursement for the product or service; validating at least a portion of the data required to authorize reimbursement against a predetermined threshold; and populating an electronic referral with the medical data and data retrieved from the one or more databases associated with the patient, the referring entity, the treatment and the provider such that the electronic referral contains information required by an authorizing entity.

In another embodiment, a computer program product for processing a referral is provided. The computer program product is embodied on one or more computer-readable media and includes computer-executable instructions for: receiving information from a user identifying a referring entity from a plurality of referring entities, a patient from a plurality of patients, a treatment from a plurality of treatments and a provider from a plurality of providers stored in one or more databases; in response to receiving the information, prompting the user to provide medical data required to authorize the treatment; and populating an electronic referral with the medical data and data retrieved from the one or more databases associated with the patient, the referring entity, the treatment and the provider such that the electronic referral includes information sufficient for authorization by an authorizing entity.

### BRIEF DESCRIPTION OF THE SEVERAL VIEWS OF THE DRAWING(S)

Reference will now be made to the accompanying drawings, which are not necessarily drawn to scale, and wherein:

FIG. 1 is a schematic diagram of an electronic referral system in accordance with an embodiment of the present invention.

FIG. 2 is a schematic diagram of an exemplary architecture of an access terminal.

FIG. 3 is a schematic diagram showing an exemplary architecture for a Referral Coordination Server 50 in accordance with an embodiment of the present invention

FIG. 4 is a block diagram showing a database structure for an exemplary database 22 in accordance with an embodiment of the present invention.

FIG. 5 is a flow diagram illustrating steps to process a new referral in accordance with an embodiment of the present invention.

FIG. 6 is a flow diagram illustrating the steps to enter or edit patient data in accordance with an embodiment of the present invention.

FIG. 7 is a flow diagram illustrating the steps to create a new referral in accordance with an embodiment of the present invention.

FIG. 8 is a flow diagram illustrating the steps for a physician to approve a pending referral in accordance with an embodiment of the present invention.

FIG. 9 is a flow diagram illustrating the steps for a provider to retrieve a referral in accordance with an embodiment of the present invention.

### DETAILED DESCRIPTION OF THE INVENTION

The present invention now will be described in greater detail with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the relevant field. Like numbers refer to like elements throughout.

As will be appreciated by one skilled in the relevant field, the present invention may be embodied, for example, as a method, a data processing system, or a computer program product. Accordingly, the present invention may take the form, for example, of an entirely hardware embodiment, an entirely software embodiment, or an embodiment having both software and hardware components. Furthermore, the present invention may take the form of a computer program product on a computer-readable storage medium having computer-readable program code embodied in the storage medium. Any suitable computer-readable storage medium may be utilized including hard disks, CD-ROMs, optical storage devices, or magnetic storage devices.

The present invention is described below with reference to block diagrams and flowchart illustrations of methods, apparatuses (e.g., systems) and computer program products according to various embodiments of the invention. It will be understood that each block of the flowchart illustrations and combinations of blocks of these flowchart illustrations can be implemented by computer program instructions. These computer program instructions may be loaded onto a general purpose computer, special purpose computer, or other programmable data processing apparatus to produce a machine to implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions for implementing the functions specified in the various flowchart block or blocks. The computer program instructions may also be loaded onto a computer or other programmable data processing apparatus to cause a series of operational steps to be performed on the computer or other programmable apparatus to produce a computer implemented process. In such an embodiment of the invention, the instructions that are executed on the computer or other programmable apparatus may serve to implement the functions specified in the flowchart block or blocks.

Accordingly, blocks of the block diagrams and flowchart illustrations and the text of this patent application support systems and methods for performing the specified functions, as well as computer readable media storing computer-executable instructions for performing the specified functions. It will also be understood that each block within the flowchart illustrations, and combinations of blocks within the flowchart illustrations, can be implemented by special purpose hardware-based computer systems that perform the specified functions or steps, or by combinations of computer hardware and computer instructions.

System Architecture

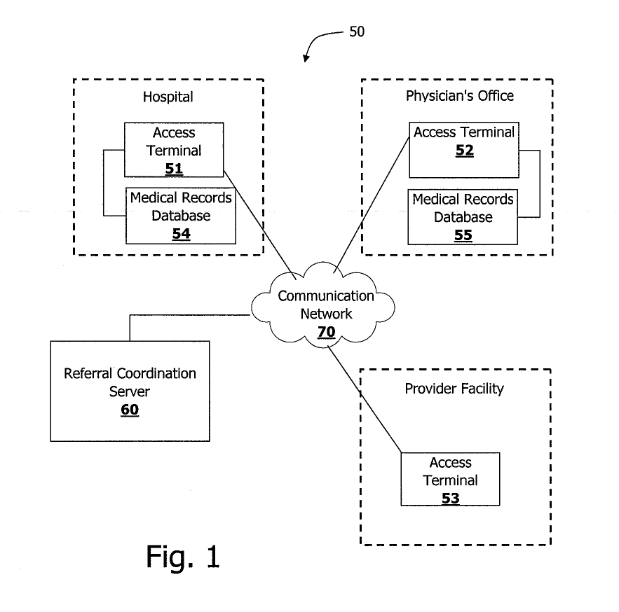

FIG. 1 illustrates an exemplary Referral Coordination System 50 according to one embodiment of the present invention. As may be understood from this figure, this exemplary Referral Coordination System 50 includes a hospital access terminal 51, a physician access terminal 52, a provider access terminal 53, a Referral Coordination Server 60, and one or more communications networks 70 for facilitating communication between the various computers and the Referral Coordination Server 60. These one or more communications networks 70 may include any of a variety of types of networks such as a public switch telephone network (PSTN), the Internet, a private intranet (LAN or WAN), or any other type of suitable network. In one embodiment of the invention shown in FIG. 1, the communications network 70 comprises a global communications network such as the Internet.

Also within the physician's office is a medical records database 55. This database stores patient identification data such as the patient's name, address, social security number and insurance. This database may also include the patient's medical history. A similar medical records database 54 may also be maintained at the hospital.

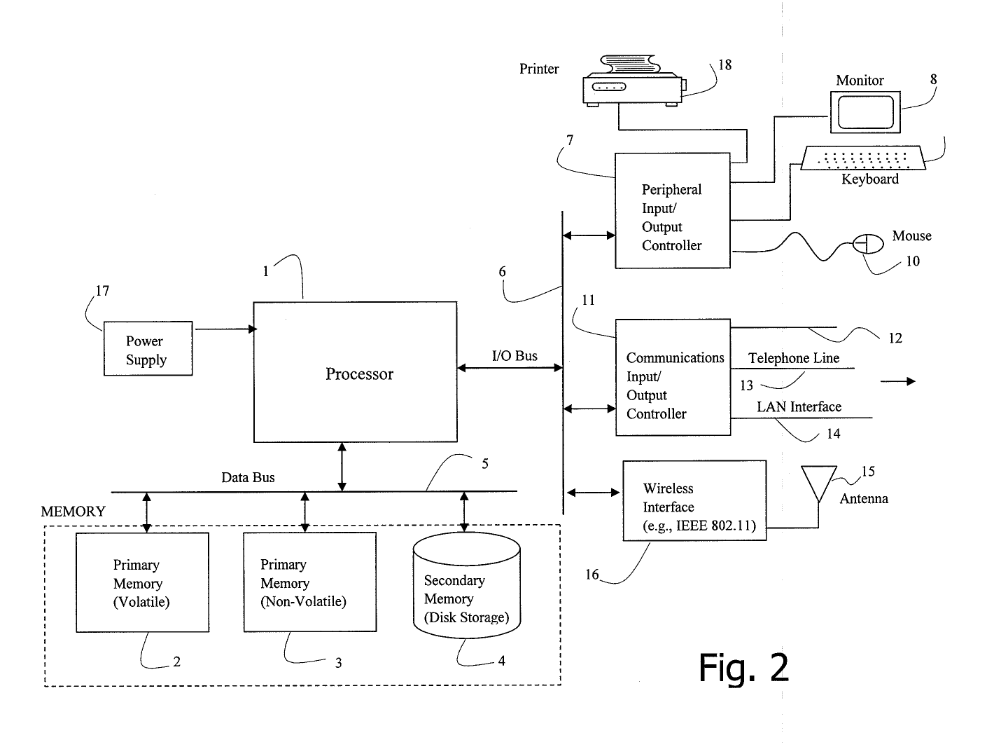

Turning to FIG. 2, an exemplary structure for access terminals 51, 52, 53 is illustrated that can be used to practice aspects of the present invention. In FIG. 2, a processor 1, such as a microprocessor, is used to execute software instructions for carrying out defined steps. The processor receives power from a power supply 17 that also provide power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts. Physician, patient, provider and referral data may be stored in the secondary memory.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a graphical user interface or monitor 8, a keyboard 9, and a mouse 10 or other typical pointing devices (e.g., rollerball, trackpad, joystick, etc.).

The processor 1 of the various access terminals communicates with external communication networks 70 using a communications I/O controller 11, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with another devices, using for example, one of the IEEE 802.11 protocols, 802.15.4 protocol, or a standard 3G wireless telecommunications protocols, such as CDMA2000 1x EV-DO, GPRS, W-CDMA, or other protocol. In an alternative embodiment, the various access terminals interface with the communication network 70 using the wireless interface 16.

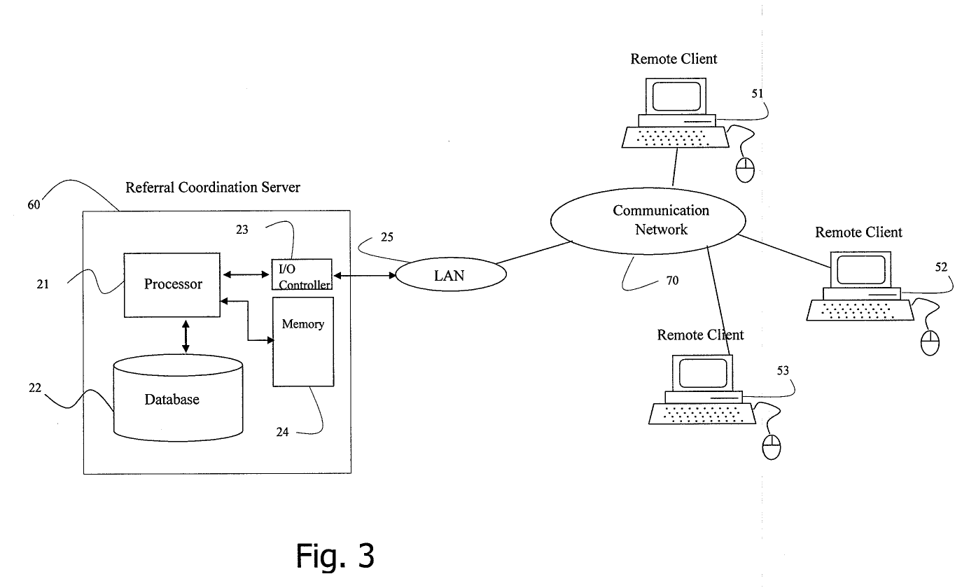

Turning to FIG. 3, a distributed communication and processing architecture is shown involving a Referral Coordination Server 60 communicating with the access terminals 51-53. In this embodiment, the access terminals operate as external clients. The Referral Coordination Server 60 includes a processor 21 that communicates with one or more databases 22, which can be viewed as a form of secondary memory, as well as primary memory 24. The processor also communicates with external devices using an I/O controller 23 that typically interfaces with a LAN 25. Communication with the access terminals is accomplished by routing data from the LAN 25 over a communications facility to the communication network 70. The access terminals may execute a web browser to interact with the Referral Coordination Server 60. More particularly, the Referral Coordination Server 60 provides an interface in the form of a website that may be accessed using access terminals 51, 52 or 53 running a web browser.

It should be understood that the Referral Coordination Server 60 may be operated by an independent entity located apart geographically from the hospital, physician's offices and the provider facilities. In an alternative embodiment, the Referral Coordination Server 60 may be operated by a physician, hospital or provider. The Referral Coordination Server 60 may be located at the physician's, hospital's or provider's location, or alternatively it may be located offsite.

The database 22 is preferably a relational database having a plurality of linked tables. Any relational database system may be used such as Oracle, DB2 or SQL Server. However, as one of ordinary skill in the art will appreciate, other types of databases may be used such as network or object based databases.

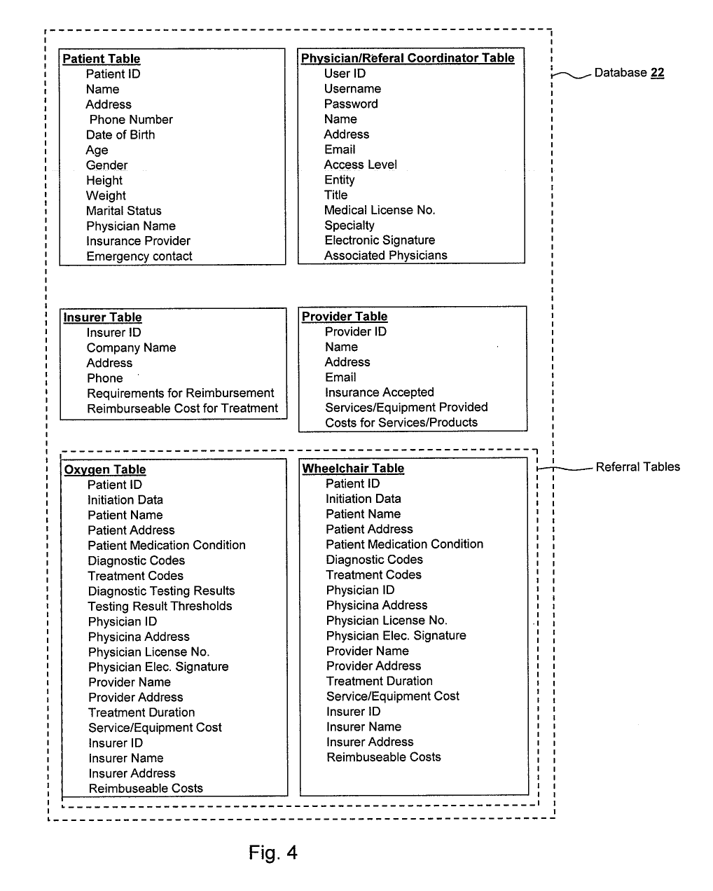

In one embodiment, database 22 is organized into a plurality of linked tables which store the data necessary to process referrals. As illustrated in FIG. 4, these tables may include a patient table, a physician table, a provider table, an insurer table, and a plurality of referral tables associated with the various types of treatments. Also illustrated in FIG. 4 are exemplary data fields that may be utilized in the associated tables. In use, the tables would contain a plurality of records comprising data in the various fields. For example, the patient table would include records for a plurality of patients. The each record would include data in one or more of the fields in the patient table such as the patient's ID code, name, address, demographic data, medical data and insurance data.

The patient table includes a record for each patient that may be identified by a patient identification code such as a serial number, telephone number, social security number or other alpha-numeric identifying code. The types of data stored in this table may include the patient's name and address, demographic data, medical conditions, physician's name, emergency contact information and insurance coverage.

Data associated with each physician having access to the system is stored in the physician table. The table may also include data associated with non-physicians such as nurses, medical assistants and referral coordinators that the physician has authorized to access the system on his behalf. Typically, the access provided to these non-physicians is more restrictive than that provided to the physician. The types of data stored in this table include a unique identification code for the user, the user's name, the business address or the user, specialty, license number if applicable. If the user is a member of a medical group, the group designation would also be included in the table. Because a physician may have greater access to the system's features, an access level associated with the user may also be stored in this table. Alternatively, the system may use the presence of a license number to distinguish between physicians and non-physicians. In a further embodiment, separate tables may be created to store data associated with non-physicians such as nurses, referral coordinators and medical assistants (not shown). This table would include similar data as the physician table and would associate the individual with one or more physicians.

The insurer table stores data associated with insurance companies providing coverage for some or all of the patients in the patient table. The data in the illustrated embodiment includes an insurer's identification code (“ID”), insurer's name, address, an indication of the types of products and services covered and requirements for obtaining reimbursement. These may include medical diagnostic testing result thresholds necessary to justify reimbursement for specific treatments.

The provider table includes data for each of the services and equipment providers having access to the system. Types of data included in this table are provider identification code, provider name, address, types of equipment or services provided, cost for provided equipment/services and insurance accepted.

In one embodiment, referral tables are created for each of the products or services referred. The individual tables would include data records for each referral event. The types of data stored in the individual records for the associated product or service would include the data necessary to complete a referral form (e.g., SMN, CMN) such as the patient's name, address, prescribing physician's name, address, medical license number, provider name, and provider address. Also included are data related to the patient's medical condition such as the patient's temperature, blood pressure, and oxygen levels. Any medical condition thresholds necessary to justify the prescribed treatment may also be included in this table. While FIG. 4 shows two referral tables for illustration purposes, it should be understood that database 22 may include any number of referral tables to store unique treatments handled by the Referral Coordination System 50. Alternatively, all of the referred treatments could be stored in one table.

In operation, the tables in database 22 are preferably linked such that data could be retrieved from a record in one table to populate fields in a record in another table. For example, data associated with a particular patient in the patient table could be used to populate patient fields in a referral table record.

In one embodiment, a single database 22 is utilized for all physicians using the Referral Coordination System 50. In this case, the data for different physicians or medical groups are commingled such that patient data may be shared between physicians. Alternatively, the physician's access may be restricted based on the physician's level of access, password or an indication in the patient's record that only certain physicians are granted access to their records. In another embodiment, separate databases may be created for individual physicians or groups of physicians. The database structure would be similar for the different physicians but the databases would be maintained independently. Therefore, per this alternative, the physician or group of physicians would only have access to their own patient data and data would not be commingled with other physician's patient data.

Those skilled in the art of data networking will realize that many other alternatives and architectures are possible and can be used to practice the principles of the present invention.

System Functionality

Embodiments of the present invention provide improved systems and methods for coordinating and processing referrals for products or services. In a medical context, physicians often refer patients to a provider for recommended or prescribed treatments such as physical therapy, diagnostic testing, nursing care, and medical equipment rental or purchase. Although the present invention will be described in the context of referrals for medical treatments, a person of ordinary skill in the art will recognize that the present invention may be used in conjunction with any referral system, and is especially useful where payment for services is provided by a third party such as insurance companies for automobile collision repair or home repair after a natural disaster, or financial institutions for appraisals. In addition, embodiments of the present invention may also be used for coordinating the filling of drug prescriptions.

Entering a New Referral

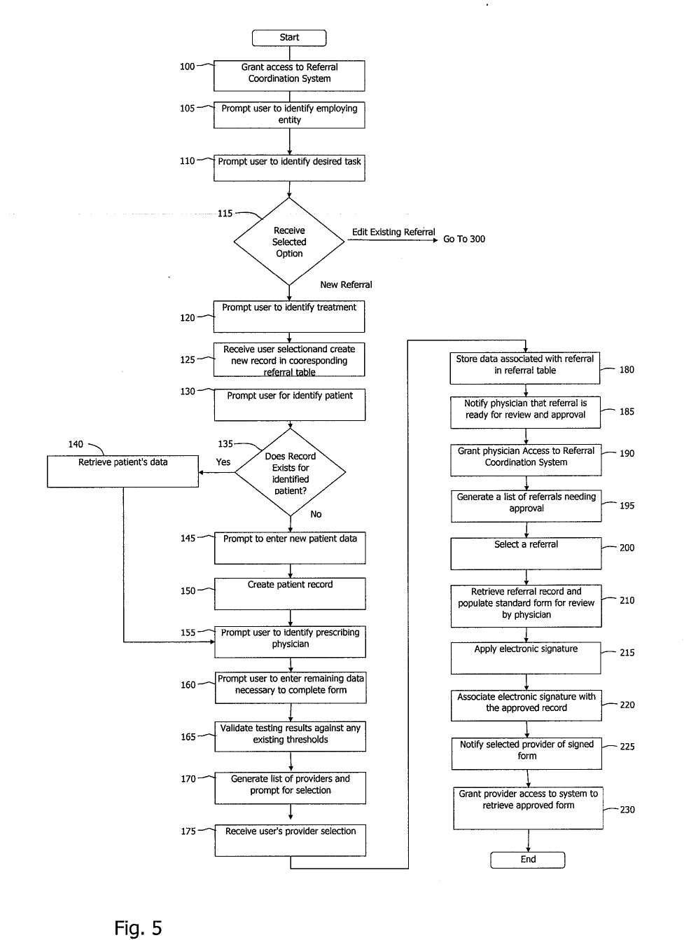

Turning to FIG. 5, a flowchart illustrating steps to process a new referral in accordance with an embodiment of the present invention is provided.

Prior to entering the system, a physician diagnoses a patient and prescribes a therapy that requires support from a provider. This treatment, for example, could be physical therapy, home nursing care, home medical supplies, home oxygen, sleep studies, sleep equipment, nebulized medication and equipment, laboratory testing, or a referral to a specialist such as a cardiologist or chiropractor.

After receiving the prescription from the physician, a nurse, medical assistant or referral coordinator (collectively referred to as a “referral coordinator”) accesses the Referral Coordination System 50 via communication network 70 using access terminal 52 at Step 100. In an alternative, a physician may perform this referral entry process. To gain access to the system, the referral coordinator enters a unique password such as the referral coordinator's username and personal identification number (PIN), or other unique identification code. The password is used by the Referral Coordination System 50 to track the movements of the user within the system.

After validating the password by querying the physician table within database 22, the Referral Coordination System 50 prompts the referral coordinator to identify the referring entity at Step 105. This may be a sole practitioner, a medical group or a hospital. To aid the referral coordinator, the Referral Coordination System 50 may provide a menu listing the entities having access to the referral system for the referral coordinator's selection or only entities associated with the referral coordinator's password. In an alternative embodiment, the entity is automatically selected based on data associated with the referral coordinator's password in the physician table. As will be explained in greater detail later, this data may be used to restrict a referral coordinator's access to patient records in the patient table.

At Step 110, a menu of options tailored to the referral coordinator's level of access is provided. In one embodiment, the referral coordinator's level of access includes entering new referrals, editing existing referral, entering patient data and providing feedback on a provider. In this embodiment, the referral coordinator would not have access to authorize a referral. At Step 115, the referral coordinator selects the “entering a new referral” option.

For a new referral, the system prompts the referral coordinator to identify the desired treatment at Step 120 by providing a menu of treatment options from which the referral coordinator is requested to select. At Step 125, the Referral Coordination System 50 receives the referral coordinator's selection and creates a new data record in the corresponding referral table in database 22. The new record includes fields necessary to complete authorization forms as will be discussed later and may also include medical thresholds necessary to justify the selected treatment. In an alternative embodiment, the medical thresholds are dictated by the payment entities as part of the requirements for reimbursement. Therefore, per this alternative, the fields associated with medical thresholds would be populated based on a link with the insurer table by using an identified patient record to locate the appropriate insurance record in the insurer table.

At Step 130, the referral coordinator is prompted to identify the patient being referred. The identifying information entered by the referral coordinator may include the patient's name, a social security number, telephone number, zip code or unique alpha-numeric patient identification code. In one embodiment, the referral coordinator enters the patient's social security number and the first two letters of their last name in order to identify the patient. At Step 135, the Referral Coordination System 50 uses the entered identification data to locate the associated patient's record in the patient table within database 22. If a record is identified, it is retrieved from the patient table within database 22 at Step 140 and the data is used to populate fields within the newly created record in the referral table. The data retrieved may be presented to the user for confirmation before populating the referral table. In an alternative embodiment, a keyword search function is provided to assist the referral coordinator to identify the patient. In a further embodiment, the referral coordinator is allowed to filter the patient table within database 22 based on the patient's first name, last name, date of service, or other desired criteria. The referral coordinator then browses the results and selects the desired patient record from the filtered list. In one embodiment, browsing is limited to patients associated with physicians identified in the referral coordinator's record in the physician table. Alternatively, the referral coordinator may be able to browse all patient records.

In the event a patient record is not located at Step 135, the system prompts the referral coordinator for additional patient information at Step 145 so a new patient record can be created in the patient table. This additional information may include street address, telephone number, social security number, medical conditions (e.g., high blood pressure, diabetes, etc.), employment, employer address and insurance information. In one embodiment, this information is key-entered by the referral coordinator. In another embodiment, this data is pasted from the physician's electronic medical records database 55 by the referral coordinator. In an alternative embodiment, the Referral Coordinator System 50 queries the physician's medical database 55 to retrieve the necessary information to populate the patient table within database 22. At Step 150, a new patient record is stored in the patient table within database 22 for future retrieval as necessary.

At Step 155, the system prompts the referral coordinator to identify the prescribing physician using the physician's name, practice name or other identifying data. Alternatively, the system may provide a list of physicians associated with the referral coordinator's password from which the referral coordinator can choose. For example, a referral coordinator may work in a practice having multiple physicians. In this case, the system would list each of the physicians in the associated practice. In a further embodiment, the system provides a browsing function that allows the referral coordinator to filter the physician table to locate the appropriate physician. The physician records may be filtered by practice name, physician name, or other desired criteria. In one embodiment, the referral coordinator can only browse physicians associated with the entity identified in Step 105 or identified in the referral coordinator's record in the physician table.

At Step 160, the referral coordinator is prompted to enter data necessary to complete the form. This data may include initiation date, requested date for the service, standard medical diagnostic codes, and diagnostic testing results. The referral coordinator typically retrieves the necessary data from the patient's medical file maintained by the physician and enters this data into the Referral Coordination System 50 using access terminal 52. Drop down menus may be provided to assist the referral coordinator in completing this process. In one embodiment, help keys/buttons are provided that when activated may provide a more detailed description of the data required. In addition, the help buttons may display the associated rules and regulations to assist the referral coordinator in populating the required fields. If the newly created record in the referral table indicates a threshold, the Referral Coordination System 50 validates the testing results entered by the referral coordinator against the identified thresholds at Step 165. If the thresholds are not met, the referral coordinator is notified and provided an opportunity to review and edit the testing results to correct any mistakes. In one embodiment, the referral coordinator is not allowed to proceed with the patient's referral if the associated thresholds are not met.

At Step 170, the Referral Coordination System 50 generates a list of providers that can furnish the recommended or prescribed treatment from the provider table within database 22. In one embodiment, the providers are filtered based on the particular patient's data. For example, the Referral Coordination System 50 may only list providers accepting the patient's insurance based on a link with the insurer table or only list providers within a distance threshold from the patient's work and/or home address. In one embodiment, the providers are listed in sequence based on a rating provided by the physician. This rating would typically be based on patient feedback or other experiences with the particular provider. In a still further embodiment, the providers are listed according to the total number of referrals received by the referral coordinator or by all referral coordinators. In another embodiment, only providers servicing within a selected zip code or group of zip codes is provided for selection by the referral coordinator. In this case, the identification of the providers may be based on the zip code of the patient's home or office or may be entered by the referral coordinator. One or more filtering criteria may be used to determine which providers are presented and in what sequence. The referral coordinator selects the desired provider at Step 175.

At Step 180, the data entered by the referral coordinator is stored in a referral record for the associated patient. In one embodiment, the Referral Coordination System 50 prompts the referral coordinator to confirm the data provided by selecting a finished or submit button at the conclusion of data entry. Alternatively, the Referral Coordination System 50 may display all of the data entered so the referral coordinator can confirm its accuracy. In this embodiment, the referral coordinator would be allowed to alter the data as necessary to correct any mistakes. It should be understood that the system may create a record when data is first received for a particular referral.

At Step 185, a notification is sent to the prescribing physician alerting him or her that the referral document is ready for review. The notification is preferably sent by email to the physician and may include an indication of the patient, the prescribed service and other data as desired such as the date of service. Alternatively, the email may only identify the number of referrals awaiting the physician's review. As one of ordinary skill in the art will appreciate, the notification may be sent using an automated phone service, pager service, an instant message or other communication system known or developed.

In a further embodiment, a courtesy notice is sent to the selected provider stating that they have been preliminarily selected to provide a service. This notice may include the patient's name and identifying information, the type of service referred, the duration, and the referring physician. In some cases, the provider could use this preliminary notice to begin providing the prescribed service. However, this would typically not be enough to secure payment from a reimbursing entity. In a further embodiment, the provider is given the option to accept or refuse the order. If refused, the system notifies the referral coordinator such that a different provider may be selected.

In response to receiving the notice, the physician accesses the system at Step 190 by entering the physician's associated password on access terminal 52. It should be noted that the physician may also access the system using access terminal 53, a home computer or any other computer having access to communication network 70. The login procedure for the physician is similar to that described above with reference to the referral coordinator.

At Step 195, the system generates a list of referrals from the referral tables awaiting the physician's review and authorization. The list may include the patient's name, the type of service referred, the prescription and/or the prescription initiation date. However, one of ordinary skill in the art will recognize that the list may include other data as desired. Various reports may be generated from the linked tables in a known manner.

At Step 200, the physician selects a particular referral to review and at Step 210 the patient's referral record is retrieved from the associated referral table. The system also retrieves and populates the appropriate authorization form. This populated form is displayed on the access terminal's graphical user interface 8 for the physician's review. The form may be a SMN, a CMN or other authorization form. In one embodiment, physician can edit data on the form as necessary. Alternatively, the physician may return the referral back to the referral coordinator for correction if a problem is identified. If the physician edits a field associated with a threshold, the Referral Coordination System 50 may validate the edited data against the threshold before allowing the physician to proceed. A pop-up window alerting the physician of the threshold may also be provided.

In an alternative embodiment, the data is provided in a customized format which is reviewed by the physician. The physician may edit and approved the data on this form and the system may then transfer the data from the customized form to a standard SMN, CMN and/or other authorization form.

After the physician is satisfied with the data reviewed, she applies an electronic signature at Step 215. As one of ordinary skill in the art will appreciate, any known or developed electronic signature process approved by government or private reimbursement entities may be used in connection with embodiments of the present invention. Examples of electronic signature guidelines that may be utilized in connection with the present invention include the Digital Signature Guidelines distributed by the American Bar Association and available at http://www.abanet.org/ftp/pub/scitech/ds-ms.doc. Another source of electronic signature guidelines includes those provided by the federal government under the Federal Electronic Signatures in Global and National Commerce Act (the “Federal Act”) and promulgated as 15 U.S.C. §7001. In one embodiment, the electronic signature includes the physician's name, a transaction number and a date.

At Step 220, the system stores the electronic signature of the physician in the appropriate field in the referral table record. At Step 225, the system notifies the selected provider that a signed authorization form is ready for their retrieval. The notification may be sent using any communication system such as an automated telephone system, an email or instant message. In an alternative embodiment, the system sends an electronic copy of the signed form by email. In a further embodiment, the system generates a hardcopy of the form that is mailed to the provider. In another embodiment, the referral coordination system provides a list of forms awaiting retrieval from a particular provider when the provider accesses the system.

At Step 230, the provider retrieves the data record from the referral table and generates an authorized form. A hardcopy of the authorization form may be generated by the provider to facilitate filing by mail. In an alternative embodiment, the authorization form is sent electronically to the reimbursing entity either from the Referral Coordination System 50 or by the provider. In another embodiment, the referral data record is presented to the provider in a customized form for easy review. If desired, the authorization form with the physician's signature could be generated at a later time.

In a further embodiment, the provider is given the option to accept or refuse the order. If refused, the system would notify the referral coordinator such that he or she may select a different provider. In an alternative embodiment, the system does not provide a notification and the provider would instead contact the referral coordinator regarding the refusal of the order by other means (e.g., telephone, email). In this case, the system would allow the referral coordinator to retrieve the referral and select a different provider if the originally selected provider refused the referral.

In one embodiment, a log file is created in database 22 each time a user accesses the Referral Coordination System 50. This log file records the type of actions taken by a user during a particular session such as viewing or editing a record and the date and time of each action and associates this data with the user's record stored in the user database. The log file may be retrieved as desired by querying the database 22 using the user's password, user name, record number, date, or other desired criteria. As will be understood by those of ordinary skill in the art, other methods available or developed may be used to track a user's movement within a database in connection with embodiments of the present invention.

Reviewing and Editing Existing Referral

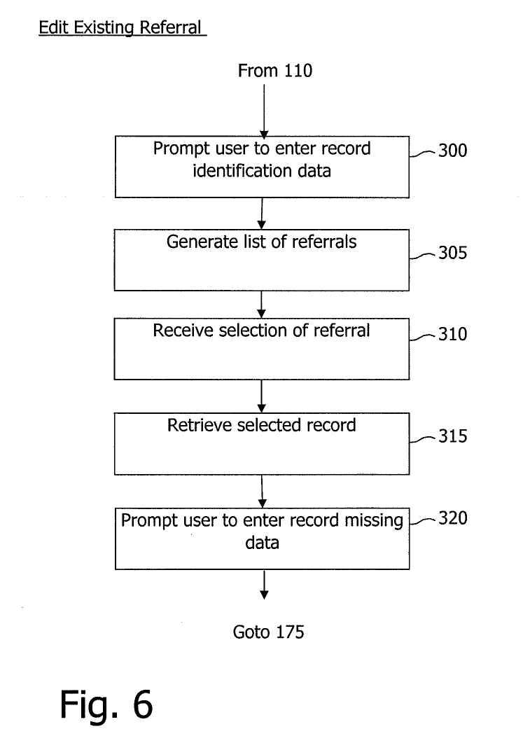

In the event a user did not have the opportunity to complete the referral entering process, an embodiment of the present invention stores the partially completed form in the referral table and allows the user to retrieve the partially completed record and finish the data entry or authorization process at a later time. In this case, the user may be a physician, nurse, referral coordinator or other authorized user. This process is illustrated in FIG. 6.

To retrieve an existing record, the user accesses the system as generally described above. When prompted, the user selects “reviewing an existing referral” option. At Step 300, the Referral Coordination System 50 prompts the user to enter identification data to locate the desired data record in the referral table. The data prompt may request the patient's name, the referred service, the patient's social security number or other identifying data. Using this entered data, the Referral Coordination System 50 queries the referral tables to generate a list of one or more records associated with the entered data at Step 305.

At Step 310, the user selects the desired record and at Step 315 the system retrieves the selected record from the referral table. At Step 320, the system prompts the user to enter any missing data. In an alternative embodiment, the system displays the necessary fields and associated data entered to date. Missing fields may be highlighted in order to draw the user's attention. After new data is entered, the record is updated and the process returns to Step 185 on FIG. 4.

Entering Patient Data

In one embodiment of the present invention, users of the system can enter patient data without an associated referral. In this embodiment, a user would log into the system as generally described in relation to FIG. 4 and the system would provide an option for entering patient data at Step 110. After this option is selected, the system would prompt the user to enter patient data and would create a patient record in the patient table within database 22. In one embodiment, the system downloads patient data from a physician's existing electronic record system.

In an alternative embodiment, a user can retrieve and edit an existing patient record. In this embodiment, the user would enter the system as generally described in relation to FIG. 4 and the system would provide the option of editing an existing patient's data. After selecting this option, the system would prompt the user to enter patient identification data. Using this data, the system would query the patient table within database 22 and generate a list of records associated with the data entered. After a selection is made, the system would display the existing data associated with the record and allow the user to alter the data as desired.

Entering a Referral At a Hospital

Under some circumstances, a referral may occur while the patient is in a hospital rather that at the physician's office. In this case, the referral coordinator entering the Referral Coordination System 50 typically works for the hospital rather that a specific physician or group of physicians. These referral coordinators may administer referrals for any physician with patients at the associated hospital. Embodiments of the present invention are provided to process this type of referral.

In one embodiment, the same general process illustrated in FIG. 4 is followed with some exceptions. The referral coordinator accesses the system using a user name and password on access terminal 51 and the system prompts the user for information related to the patient and the referral services needed. To enter the required data, the referral coordinator will utilize hospital medical records as opposed to the physician's records as discussed in relation to the previous embodiment. In one embodiment, the system may retrieve the necessary biographical and medical data directly from the hospital's electronic records system. In an alternative embodiment, the referral coordinator key-enters the data from the medical records based on electronic or paper records.

Under one scenario, the physician is still at the hospital when the referral information is entered by the hospital's referral coordinator. In this case, the physician may utilize an access terminal at the hospital to review and sign the associated document. A benefit of this embodiment is that the physician can verify the referral system's data against the actual hospital records prior to applying an electronic signature and the entire authorization procedure is completed efficiently when the needed information is fresh and at hand.

Under another scenario, the prescribing physician is no longer at the hospital when the referral entry is complete. In this case, the physician may access the Referral Coordination System via access terminal 52 at his office to review the document and apply an electronic signature to the form.

### Alternative Embodiments

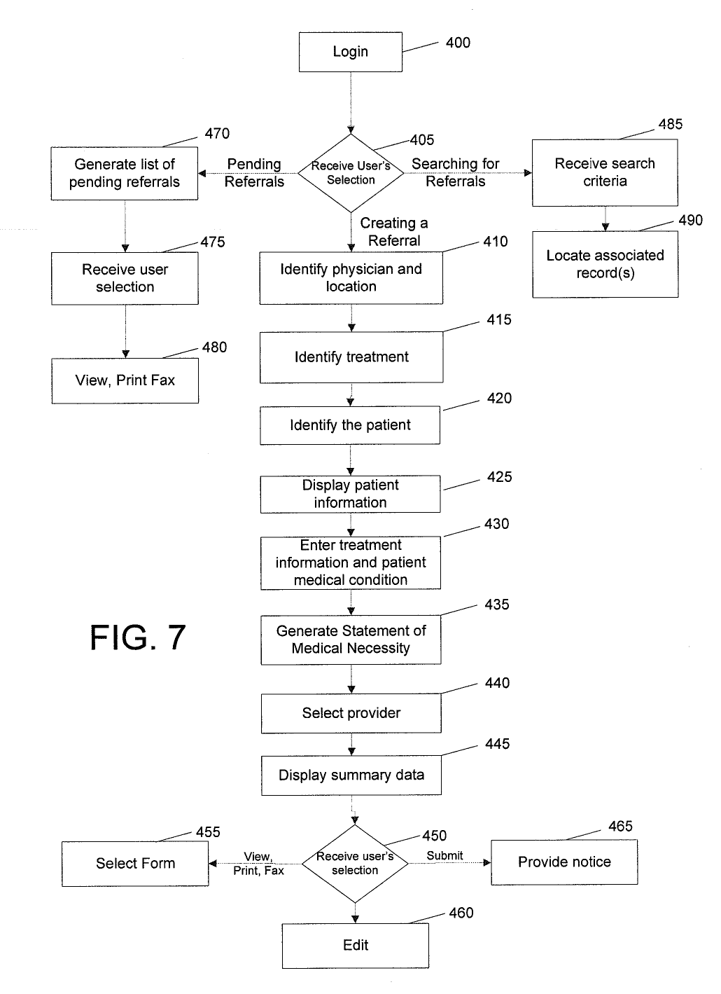

Turning to FIG. 7, an alternative embodiment for generating a referral will now be described. The process starts at Step 400 with the person responsible for initiating the referral logging into the system. This person is typically a referral coordinator, but the person may be a physician, a nurse or other authorized person. The login procedure may require the user to enter both a username and a password. As will be appreciated by those skilled in the art, any type of login procedure, known or developed, may be used in connection with the present invention.

After the system verifies the person's login information, the system provides the user with a menu of options at Step 405 such as pending referrals, searching for referrals and creating a referral from which to choose from. Selecting the pending referrals option allows a user to review and print existing referrals that are awaiting the physician's approval. These pending referrals are also referred to as preliminary referrals herein. The searching referrals option allows a user to locate a particular referral using keyword searching. In either case, once a referral is located or selected, the user may view, print or fax the data associated with the referral in any of a plurality of formats such as CMN, SMN or a custom form. These options will be discussed in greater detail later.

Assuming the user selects the “creating a referral” option at Step 405, the system then prompts the user to identify the physician and the affiliated location at Step 410. Often, a physician has several offices or has privileges to work one or more hospitals. This allows the system to identify the location where the referral was initiated. The system may provide a list of physicians and locations from which the user can choose as discussed in relation to other embodiments. Search functions may also be provided where the user enters identifying information about the referring entity and the system locates the appropriate record.

After identifying the physician and location at Step 410, the process continues to Step 415 where the system prompts the user to identify the treatment needing a referral. In one embodiment, the system provides a drop-down menu of the most popular treatments with the option of searching for a non-listed treatment. In a further embodiment, the treatments most often referred by the identified physician or user are provided with the search option for treatments not listed. In another embodiment, only the search option is provided.

Proceeding to Step 420, the system prompts the user to identify the patient such that the patient's records can be retrieved from one or more databases. In one embodiment, the user is asked to enter the patient's social security number and the first two letters of his or her last name. It should be understood that any identifying patient information may be used, by itself or in combination with other data, to locate a patient's records such as the patient's name, address, birth date, social security number or unique patient number.

Using the information entered in Step 420, the system retrieves the patient's records and displays at least some information from the records for the user to review at Step 425. The displayed information may include social security number, name, address, telephone number, birth date, physical characteristics (e.g., height, weight) and insurance information. Other data in the patient's records may not be displayed at this stage such as other referrals for this patient.

In one embodiment, the user is allowed to edit the patient's data displayed at Step 425. In alternative embodiments, the ability to edit a patient's records may be restricted to the user or physician that initially entered the patient's information into the system. In other embodiments, all users may be allowed to alter select information while others have full editing authorization. Editing authorization may be controlled based on a username or password.

The process continues to Step 430 where the system prompts the user to enter information related to the referred treatment. The type of information prompted for may include the location of the service (e.g, at home, physical therapy clinic), the date last seen by the physician, the length of time needed for the treatment, a prognosis and diagnosis codes. In addition, the system may prompt the user to answer specific questions regarding the physical condition of the patient necessitating the referral. This information is often required by a reimbursing entity before authorizing payment. In one embodiment, the system tailors the questions according to the treatment referred. For example, if the treatment referred is in-home oxygen, the user may be asked to enter the patient's blood gas level. On the other hand, if the referred treatment is a hospital bed, the user may be asked whether positioning of the patient in ways not feasible for ordinary beds is necessary to alleviate pain. To assist users in answering the posed questions, the system may provide menus that allow a user to select the appropriate answer.

As with previous embodiments, the system may verify data entered against predetermined thresholds. If a threshold is not met, additional questions may be asked and/or the user may be notified that an entry does not meet a threshold. In one embodiment, the user is allowed to create a referral even if the thresholds are not met. In an alternative embodiment, the user may be prevented from continuing with the referral if the thresholds are not met.

At Step 435, the system arranges the answers to select questions in combination with standard language to generate a narrative statement of medical necessity. For example, the system may create the following sentence: “Due to a patient's medical condition, a [insert answer to question 1] is required: due to [insert answer to question 7].” In this example, questions 1 and 7 were posed to the user earlier in the process and the user's answers to these questions are inserted in the sentence above where indicated to generate a statement of medical necessity. In one embodiment, the user is allowed to edit this statement as desired. The system may also provide an area where the user can enter special instructions for the patient or provider.

The process then continues to Step 440 where the system prompts the user to identify a provider. In one embodiment, the system gives the user a list of providers preferred by the physician from which the user can choose. This list may be generated based on a rating given to the provider by the physician, the number of referrals issued by the physician to given providers or any other desired criteria. Alternatively, the system may provide a search function allowing the user to search for a provider by name or zip code serviced. In a further embodiment, the system offers both of the above methods for identifying a provider.

At Step 445, the system displays a summary of the data entered and provides the user with the option of viewing, printing, faxing, editing the information displayed or submitting the information to the system. If the user selects the view, print or fax option at Step 450, the system provides a menu of different formats (e.g., different standard forms) in which the data may be viewed, printed or faxed at Step 455. For example, the user may select a CMN, an SMN or a custom form, and the system will populate the appropriate form with the data entered. Once a form is populated, the actual form itself may be stored in the database for subsequent retrieval and viewing, printing or faxing. As a second form is populated, it may also be stored. In one embodiment, each of the offered formats is populated and stored for subsequent viewing, printing or faxing when the data is “submitted” by the user.

Assuming the user selects the editing option, the system then displays the data in a custom form and allows the user to change some or all of the data entered at Step 460. In some embodiments, the user may not be authorized to change some of the patient data retrieved from the one or more databases such as the patient's social security number.

Assuming the “submit” option is selected at Step 450, the process continues to Step 465 where the system notifies the physician and the selected provider that a preliminary referral has been submitted. In one embodiment, the notice is an email to the physician and the provider that includes a link to the system allowing the recipient to easily access the system. The link may direct the recipient to the login screen where she can enter her username and password to access the system. In an alternative embodiment, the link connects the user directly to the submitted form. Other notification methods may also be used as discussed in relation to other embodiments such as an automated phone message, a page, an instant message or other communication method known or developed.

Returning to Step 405, assume now that the user selects the pending referrals option. In this case, the system generates a list of pending referrals associated with the user at Step 470. The user may also be able to access referrals associated with his or her associated physicians or physician groups. The user then selects a referral from the generated list at Step 475 and may then view, print or fax the pending referral in any of a plurality of formats (e.g., CMN, SMN or custom form) at Step 480.

Now assume the user selects the search option at Step 405. In this case, the system prompts the user to enter identifying information for the referrals at Step 485. This information may be a patient's name, a patient's social security number, the treatment referred or other identifying information. The system then uses this information to locate the appropriate record at Step 490. This record may then be viewed, printed or faxed in one or a plurality of formats.

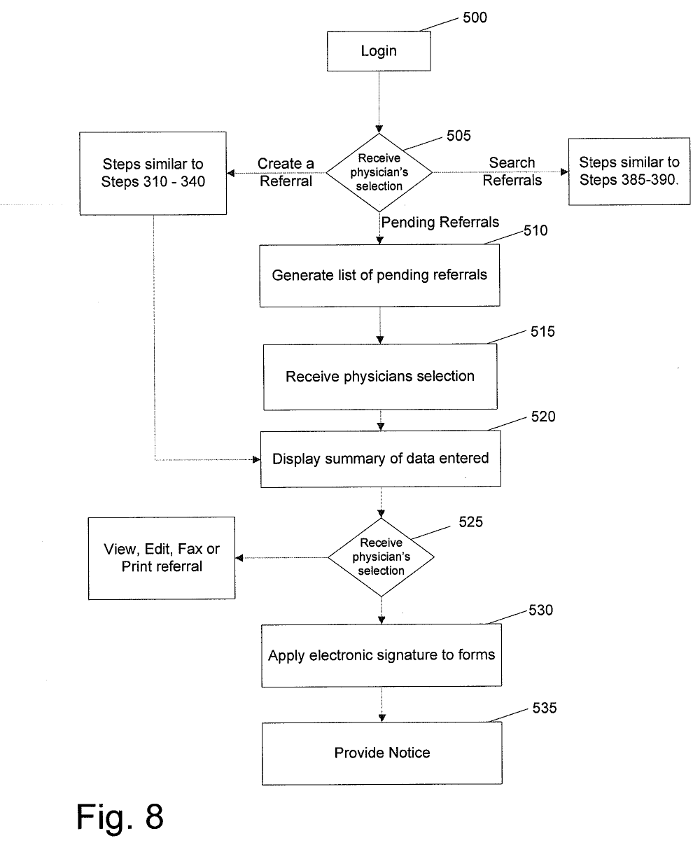

Turning now to FIG. 8, the process by which a physician approves a referral in accordance with an embodiment of the present invention will be described. Starting at Step 500, the physician logs into the system using a process similar to that described above with reference to Step 400. At Step 505, the system provides the physician with a menu of options including creating a referral, pending referrals, and search for referrals from which to select from. The creating a referral option is similar to the creating a referral option described in Steps 410-440. In addition, the search option is similar to the search option described in Steps 485 and 490.

Assuming the physician selects the pending referrals option at Step 505, the process continues to Step 510 where the system prepares a list of pending referrals for the logged in physician. The list includes referrals that have been submitted and are awaiting approval from the physician. In one embodiment, the referrals in the generated list are in order based on submission date ending with the most recent.

At step 515, the physician selects the desired referral, and the system displays a summary of the data entered at Step 520. The system then provides the physician the option to view the data in a specific form (e.g., CMN, SMN or custom form), print the data in a desired form, edit the entered data or approve the form.

If the physician selects the approval option, the physician's electronic signature is applied to the form at Step 530. In one embodiment, the electronic signature includes the physician's name, a transaction number generated by the system and the date the referral was approved. At this point, the referral form is complete. In one embodiment, a CMN, SMN and custom form are generated and stored in the system for subsequent retrieval as necessary. If a preliminary CMN, SMN and custom forms were generated, these are now replaced with the final versions having the physician's electronic signature.

At Step 535, a notice is sent to the provider that the approved referral is in the system. The notice may be an email with a link to the system and/or document. The provider can then log into the system and access the desired form.

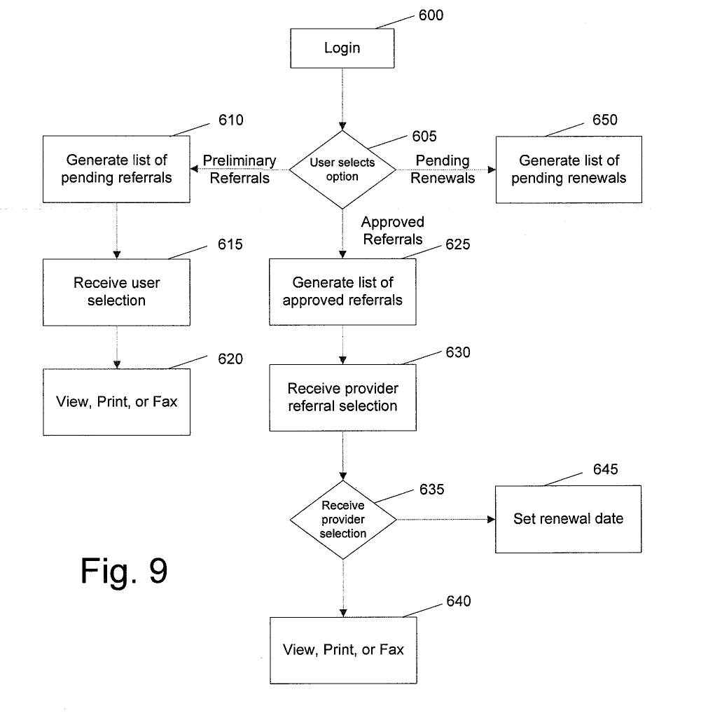

Turning to FIG. 9, the provider process for accessing referrals is described. At Step 600, the provider logs into the system by entering a username and password. After validating the username and password, the system provides a menu of options including preliminary referrals, approved referrals and pending renewals.

Assuming the provider selects the preliminary referrals option at Step 605, the process continues to Step 610 where the system generates a list of preliminary referrals associated with the provider. The provider can then select one of the preliminary referrals at Step 615 and then view, print or fax the preliminary referral in any of a plurality of formats.

Returning to Step 605, assume the provider selects the approved referrals option. In this case, the system generates a list of approved referrals (e.g., referrals having a physician's electronic signature) at Step 625. From this list, the provider can select a referral at step 630 and the system allows the provider view, print or fax the approved referral in any of a plurality of formats at Step 640. The provider may also be given the option at Step 635 of establishing a renewal date at Step 645.

Assuming the provider selects the renewal date option at Step 635, the system prompts the user to enter a date. In one embodiment, the system suggests a date that is a predetermined time period from the present date. For example, the system may suggest a date that is 365 days from the present date. The provider can accept or edit this date.

In use, the system records this date and provides a reminder to the provider prior to the recorded date. For example, the system may provide a reminder one month before the renewal date. This reminder may be an email to the provider or an indication when the provider accesses the system.

Returning to Step 605, the provider is also given the option of “pending renewals.” After selecting this option, the system generates a list of renewals for the associated provider.

### Additional Embodiments

In an alternate embodiment, the physician may enter the referral information as opposed to a referral coordinator. In this case, the physician would enter the system using her user name and password as generally described with reference to FIG. 4. After entering the system, the physician would be prompted to enter the same types of data as described for a referral coordinator. Once the data is entered, the physician would be provided the option of reviewing the authorization form and applying an electronic signature.

In another embodiment, a physician, nurse, referral coordinator or other authorized user enters a performance rating for a provider. This process will generally follow the steps outlined for entering patient data except the authorized user will select the option of rating a provider when prompted and a provider record will be located and retrieved as oppose to a patient's record. The rating may be in the form of a numerical rating, or categorical rating (e.g., Excellent, Satisfactory, and Unsatisfactory). As discussed earlier, this rating may be used to sequence providers when listed for selection. Alternatively, the selection list may include the rating. In an alternative embodiment, a user may also provide a narrative comments related to the provider.

In a further embodiment, advertising may be provided when the system is accessed. These advertisements may be targeted to specific categories of users such as nurses, physicians, referral coordinators, or providers. Also, the advertisements may also be targeted based on the medical conditions of the patients or the services referred. In one embodiment, the graphical interface provided by the Referral Coordination System 50 includes reserved space such as the margins for advertisements. Alternatively, advertisements may be programmed to suddenly appear in the foreground of the graphical user interface in response to a particular event. These types of advertisements are often referred to as banner and pop-up ads, respectively.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for processing a referral for a treatment comprising:
one or more databases configured to store data associated with a plurality of patients; a plurality of treatments including medical data requirements for authorization; a plurality of referring entities; and a plurality of providers including provider profiles;
a plurality of access terminals having an input device and a graphical user interface; and
a referral coordination server configured to communicate with said one or more databases and said plurality of access terminals and further configured for:
receiving information from a user identifying a referring entity from said plurality of referring entities, a patient from said plurality of patients, a treatment from said plurality of treatments and a provider from said plurality of providers;
in response to receiving said information, prompting said user to provide medical data required to authorize said treatment; and
populating an electronic referral with said medical data and data retrieved from said one or more databases associated with said patient, said referring entity, said treatment and said provider such that said electronic referral includes information sufficient for authorization by an authorizing entity.

2. The system of claim 1, wherein said referral coordination server is further configured for providing notice to said provider after said electronic referral has been populated.

3. The system of claim 2, wherein said notice is provided by email.

4. The system of claim 1, wherein said referral coordination server is further configured for providing an option to said provider to generate a reimbursement document in one of a plurality of formats populated with data from said electronic referral.

5. The system of claim 1, wherein said referral coordination server is further configured for:
providing notice to said authorizing entity after said electronic referral has been populated;
allowing said authorizing entity to edit said electronic referral;
receiving an electronic signature from said authorizing entity;
updating said electronic referral with said electronic signature thereby creating an authorized electronic referral; and
providing a notice to said provider of said authorized electronic referral.

6. The system of claim 5, wherein said referral coordination server is further configured for:
providing access to said authorized electronic referral by said provider; and
providing an option to said provider to generate a reimbursement document in one of a plurality of formats populated with data from said authorized electronic referral.

7. The system of claim 6, wherein said plurality of formats includes a Statement of Medical Necessity format or a Certificate of Medical Necessity format.

8. The system of claim 1, wherein said referral coordination server is further configured for providing a menu comprising at least a subset of said plurality of treatments.

9. The system of claim 8, wherein said menu includes a subset of said plurality of treatments determined based on the number of times individual treatments are referred.

10. The system of claim 1, wherein said referral coordination server is further configured for providing a menu comprising a subset of said plurality of providers.

11. The system of claim 10, wherein said subset of said plurality of providers is determined based on the provider operating in a selected geographic area.

12. The system of claim 10, wherein said subset of said plurality of providers is determined based providers honoring a particular insurance.

13. The system of claim 10, wherein said subset of said plurality of providers is determined based on the providers providing said treatment.

14. The system of claim 1, wherein said referral coordination server is further configured for:
receiving a referral expiration date; and
providing an alert in advance of said referral expiration date.

15. The system of claim 1, wherein said referral coordination server is further configured for generating a Statement of Medical Necessity using said medical data.

16. The system of claim 1, wherein said referral coordination server is further configured for:
validating at least a portion of said medical data against an associated threshold; and
providing an alert if said threshold is not satisfied.

17. A method for processing a referral for treatment of a patient comprising the steps of:
providing one or more databases for storing data associated with a plurality of patients, a plurality of referring entities, a plurality of treatments including medical data requirements for authorization, and a plurality of providers;
receiving information from a user identifying a referring entity from said plurality of referring entities, a patient from said plurality of patients, a treatment from said plurality of treatments and a provider from said plurality of providers;
in response to receiving information, prompting said user to provide medical data required to authorize treatment; and
populating an electronic referral with said medical data and data retrieved from said one or more databases associated with said patient, said referring entity, said treatment and said provider such that said electronic referral contains information sufficient for authorization by an authorizing entity.

18. The method of claim 17, further comprising the step of providing notice to said provider after said electronic referral has been populated.

19. The method of claim 17, wherein said notice is provided by email.

20. The method of claim 17 further comprising the step of providing an option to said provider to generate a reimbursement document in one of a plurality of formats populated with data from said electronic referral.

21. The method of claim 17 further comprising the steps of:
providing notice to said authorizing entity after said electronic referral has been populated;
allowing said authorizing entity to edit said electronic referral;
receiving an electronic signature from said authorizing entity;
updating said electronic referral with said electronic signature thereby creating an authorized electronic referral; and
providing a notice to said provider of said authorized electronic referral.

22. The method of claim 21, wherein said user and said authorizing entity are the same person.

23. The method of claim 21, wherein said authorizing entity is a physician.

24. The method of claim 21 further comprising the step of:
providing access to said authorized electronic referral by said provider; and
providing an option to said provider to generate a reimbursement document in one of a plurality of formats populated with data from said authorized electronic referral.

25. The method of claim 24, wherein said plurality of formats includes a Statement of Medical Necessity format or a Certificate of Medical Necessity format.

26. The method of claim 17 further comprising the step of providing a menu comprising at least a subset of said plurality of treatments.

27. The method of claim 26, wherein said menu includes a subset of said plurality of treatments determined based on the number of times individual treatments are referred.

28. The method of claim 17 further comprising the step of providing a menu comprising at least a subset of said plurality of providers.

29. The method of claim 28, wherein said subset of said plurality of providers is determined based on the provider operating in a selected geographic area.

30. The method of claim 28, said subset of said plurality of providers is determined based providers honoring a particular insurance.

31. The method of claim 28, wherein said subset of said plurality of providers is determined based on the providers providing said treatment.

32. The method of claim 17 further comprising the steps of:
receiving a referral expiration date; and
providing an alert in advance of said referral expiration date.

33. The method of claim 17 further comprising the step of generating a Statement of Medical Necessity using said medical data.

34. The method of claim 17 further comprising the steps of:
validating at least a portion of said medical data against an associated threshold; and
providing an alert if said threshold is not satisfied.

35. A method for processing a referral comprising the steps of:
providing one or more databases storing data associated with a plurality of referring entities, a plurality of products or services, and a plurality of providers;
receiving information from a user identifying a person being referred, a referring entity from said plurality of referring entities, a product or service from said plurality of products and services and a provider from said plurality of providers;
in response to receiving information, prompting said user to provide data required to authorize reimbursement for said product or service;
validating at least a portion of said data required to authorize reimbursement against a predetermined threshold; and
populating an electronic referral with said medical data and data retrieved from said one or more databases associated with said patient, said referring entity, said treatment and said provider such that said electronic referral contains information required by an authorizing entity.

36. The method of claim 35, further comprising the step of providing notice to said provider after said electronic referral has been populated.

37. The method of claim 35 further comprising the step of providing an option to said provider to generate a reimbursement document in one of a plurality of formats populated with data from said electronic referral.

38. The method of claim 35 further comprising the steps of:
providing notice to said authorizing entity after said electronic referral has been populated;
allowing said authorizing entity to edit said electronic referral;
receiving an electronic signature from said authorizing entity;
updating said electronic referral with said electronic signature thereby creating an authorized electronic referral; and
providing a notice to said provider of said authorized electronic referral.

39. The method of claim 35 further comprising the step of providing a menu comprising a subset of said plurality of products or services determined based on the number of times a product or service is referred.

40. The method of claim 35 further comprising the step of providing a menu comprising a subset of said plurality of providers determined based providers honoring a particular insurance.

41. A computer program product for processing a referral, the computer program product embodied on one or more computer-readable media and comprising computer-executable instructions for:
receiving information from a user identifying a referring entity from a plurality of referring entities, a patient from a plurality of patients, a treatment from a plurality of treatments and a provider from a plurality of providers stored in one or more databases;
in response to receiving said information, prompting said user to provide medical data required to authorize said treatment; and
populating an electronic referral with said medical data and data retrieved from said one or more databases associated with said patient, said referring entity, said treatment and said provider such that said electronic referral includes information sufficient for authorization by an authorizing entity.

42. The method of claim 41, further comprising the steps of:
providing notice to said provider after said electronic referral has been populated.

43. The method of claim 35 further comprising the steps of:
providing notice to said authorizing entity after said electronic referral has been populated;
allowing said authorizing entity to edit said electronic referral;
receiving an electronic signature from said authorizing entity;
updating said electronic referral with said electronic signature thereby creating an authorized electronic referral; and
providing a notice to said provider of said authorized electronic referral.
